(19) United States
(12) Patent Application Publication
(10) Pub. No.: US 2013/0173179 A1
(43) Pub. Date: Jul. 4, 2013

(54) METHOD FOR PREDICTING WHETHER A WOOD PRODUCT ORIGINATED FROM A BUTT LOG

(71) Applicants: John N. Giovanini, Gig Harbor, WA (US); John E. Jones, III, Seattle, WA (US); Stanley L. Floyd, Enumclaw, WA (US)

(72) Inventors: John N. Giovanini, Gig Harbor, WA (US); John E. Jones, III, Seattle, WA (US); Stanley L. Floyd, Enumclaw, WA (US)

(73) Assignee: WEYERHAEUSER NR COMPANY, Federal Way, WA (US)

(21) Appl. No.: 13/313,862

(22) Filed: Dec. 30, 2011

(51) Int. Cl. G06F 15/00; G01H 5/00; G01N 21/55

(52) U.S. Cl. 702/25; 702/189; 702/23; 702/143

(57) ABSTRACT

The present disclosure generally relates to methods for predicting whether a wood product originated from a butt log. In some embodiments, such methods include dividing the wood product into at least two sections and obtaining, for each of the at least two sections, one or more optical measurements. One or more slope values may then be calculate, each representing an estimated rate at which the one or more optical measurements vary across the wood product. The slope values may then be used in a prediction model to determine a predictive output, the predictive output indicating whether the wood product originated from a butt log. Further aspects of the disclosure are directed towards a computer-readable storage medium for executing methods according to embodiments of the disclosure.

### TECHNICAL FIELD

The present disclosure is directed generally to methods for predicting whether a wood product originated from a butt log for use in grading applications.

### BACKGROUND

In the United States and in other countries, dimension lumber is generally manufactured to standard industry sizes and sold in packages of standard piece count. For example, the standard package of 2×4 dimension lumber contains 208 pieces. Lumber packages are constructed based, at least partially, on data obtained using a variety of different lumber grading techniques. According to such techniques, each piece of lumber is inspected using visual or mechanical means to detect properties that indicate the quality of the wood and its appropriate application. Data indicating the relevant properties may then be used to assign a grade to the particular piece. Many different types of automated grading systems, equipment, and associated methods are used in the industry for categorizing lumber into the appropriate grade.

Although industry grade rules recognize the fallibility of lumber grading methods and therefore allow for a certain amount of misgrade in a standard lumber package, wood product manufacturers are continuously aiming to improve lumber grading techniques. As part of this effort, researchers are examining new properties and detecting methods that may be relevant to grading applications. For example, the type of log from which a piece of lumber originated is expected to be useful information for grading applications. Logs known in the industry as “butt logs” originate from the base of a tree and are generally considered to possess superior quality wood because there is a higher percentage of clear wood in that part of the tree stem. Butt logs can sometimes be identified visually by a flare at the base of the log; however, there is no standard, systematic, or reliable method for determining whether a particular piece of lumber originated from a butt log.

Accordingly, a need exists for a method for predicting whether a wood product originated from a butt log. Ideally, the capability to predict whether a wood product originated from a butt log could be used to more accurately assign grades or perform other types of sorting and packaging.

### SUMMARY

The following summary is provided for the benefit of the reader only and is not intended to limit in any way the invention as set forth by the claims. The present disclosure is directed generally towards methods for predicting whether a wood product originated from a butt log for use in grading applications.

In some embodiments, methods according to the disclosure include dividing the wood product into at least two sections and obtaining, for each of the at least two sections, one or more optical measurements. One or more slope values may then be calculate, each representing an estimated rate at which the one or more optical measurements vary across the wood product. The slope values may then be used in a prediction model to determine a predictive output, the predictive output indicating whether the wood product originated from a butt log. Further aspects of the disclosure are directed towards a computer-readable storage medium for executing methods according to embodiments of the disclosure.

### BRIEF DESCRIPTION OF THE DRAWINGS

The present disclosure is better understood by reading the following description of non-limitative embodiments with reference to the attached drawings wherein like parts of each of the figures are identified by the same reference characters, and are briefly described as follows:

FIGS. 1 and 2 are perspective views of a wood product;

FIGS. 3A, 3B, and 3C are schematics of a tracheid effect measurement method;

FIG. 4 is a top view of the wood product from FIGS. 1 and 2;

FIG. 5 is a plot of TracRatio slope vs. moisture content slope for an example using a method according to embodiments of the disclosure;

FIG. 6 is a plot of predicted origin location vs. actual origin location for an example using a method according to embodiments of the disclosure; and

FIG. 7 is an example of a classification and regression tree used in methods according to embodiments of the disclosure.

### DETAILED DESCRIPTION

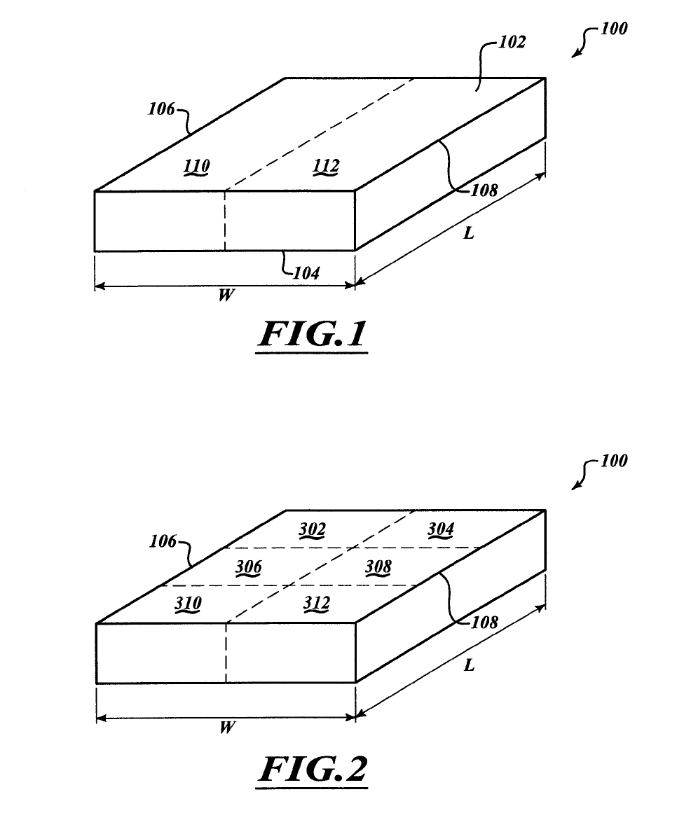

The present disclosure describes methods for predicting whether a wood product originated from a butt log. Certain specific details are set forth in the following description and FIGS. 1-7 to provide a thorough understanding of various embodiments of the disclosure. Well-known structures, systems, and methods often associated with such systems have not been shown or described in detail to avoid unnecessarily obscuring the description of various embodiments of the disclosure. In addition, those of ordinary skill in the relevant art will understand that additional embodiments of the disclosure may be practiced without several of the details described below.

Certain terminology used in the disclosure are defined as follows:

The term “wood product” is used to refer to a product manufactured from logs such as lumber (e.g., boards, dimension lumber, solid sawn lumber, joists, headers, beams, timbers, mouldings, laminated, finger jointed, or semi-finished lumber); veneer products; or wood strand products (e.g., oriented strand board, oriented strand lumber, laminated strand lumber, parallel strand lumber, and other similar composites); or components of any of the aforementioned examples.

The term “log” is used to refer to the stem of standing trees, felled and delimbed trees, and felled trees cut into appropriate lengths for processing in a wood product manufacturing facility.

The term “butt log” is used to refer to a log originating from the base of a tree.

Embodiments of the disclosure include a method for determining whether a particular wood product originated from a butt log using a series of steps. Referring to FIG. 1, in a first embodiment, a wood product 100 is provided having a top surface 102, a bottom surface 104, a first edge 106, a second edge 108, a length L, and a width W. In a first step, the wood product 100 may be divided into at least two sections along the length L. In FIG. 1, the wood product 100 is shown divided into two sections (a first section 110 and a second section 112); however, in other embodiments the wood product 100 can be divided into any number of sections of two or greater. A person of ordinary skill in the art will understand that the wood product 100 does not need to be physically divided or cut to complete this division step.

Referring to FIG. 2, in some embodiments, the wood product 100 may be further divided along the width W into at least two coupons. In FIG. 1, the wood product 100 is shown divided into six coupons: a first coupon 302, a second coupon 304, a third coupon 306, a fourth coupon 308, a fifth coupon 310, and a sixth coupon 312. In other embodiments the wood product 100 can be divided into any number of coupons of two or greater. A person of ordinary skill in the art will appreciate that wood products may be divided using methods that vary slightly from those explicitly described. For example, in some cases when the disclosure specifies that a wood product is divided along its length, a person of ordinary skill in the art may choose to divide along the width instead.

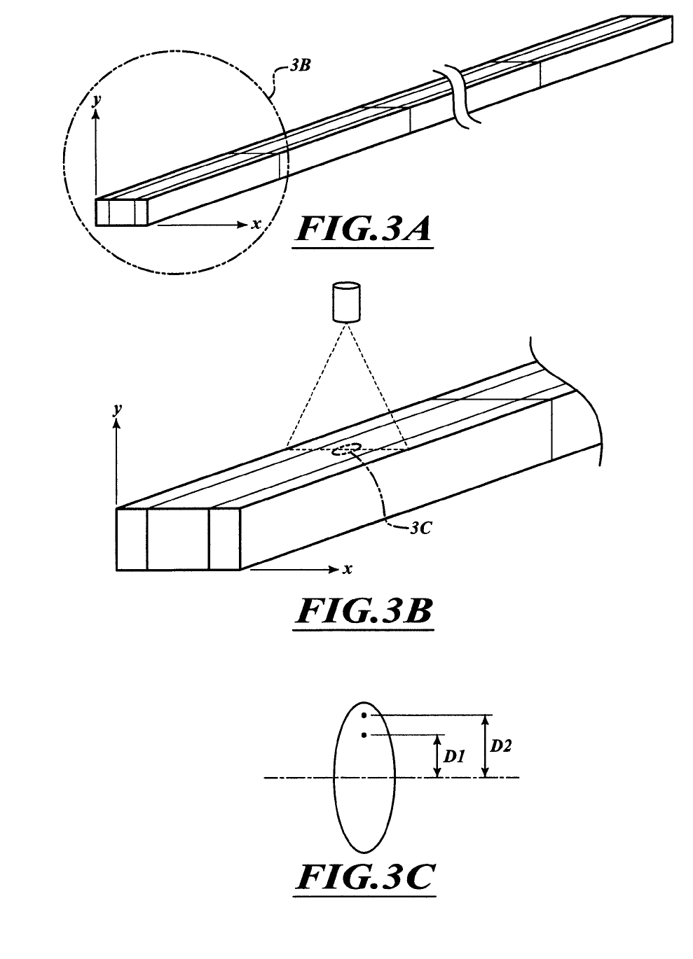

Optical measurements are then obtained from the two or more sections. One type of optical measurement useful with embodiments of the disclosure is referred to in the industry as the “tracheid effect.” A schematic of an exemplary tracheid effect measurement system is shown in FIGS. 3A, 3B, and 3C. When light illuminates an unfinished wooden surface, the wood fibers distort the pattern of reflected light in such a way that the reflected shape looks different than the incident shape. The degree to which a light spot or line is distorted by the wood is an indicator of the lengthwise shrinkage properties of the wood at that location. In addition to being referred to as a tracheid effect measurement, this phenomenon is also known to those in the industry as a “T1 measurement.” Some examples of systems and methods for measuring the tracheid effect are disclosed, for example, in U.S. Pat. No. 3,976,384, the content of which are hereby incorporated by reference. A person of ordinary skill in the art will appreciate that other types of optical measurements may be used with methods according to embodiments of the disclosure.

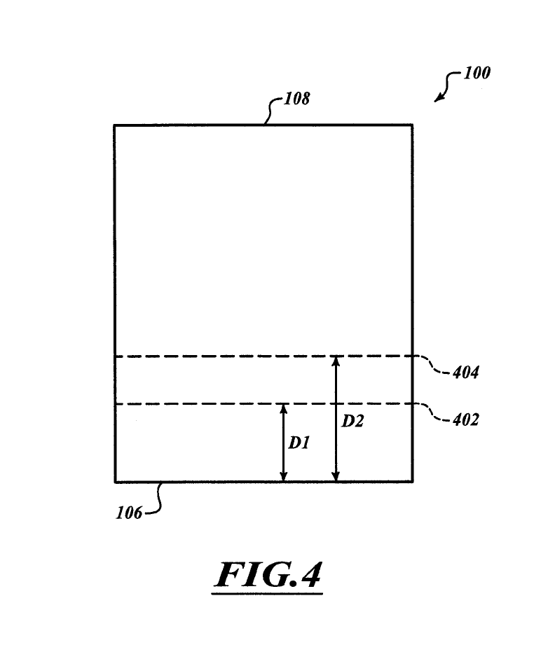

Optical measurements may be obtained from either the top surface 102, the bottom surface 104, or both the top surface 102 and the bottom surface 104. FIG. 4 is a top view of the wood product 100. Referring to FIG. 4, measurements may be obtained from a first position 402 on the top surface 102 and a second position 404 on the top surface 102. The first position 402 is a first distance D1 away from the first edge 106 and the second position is a second distance D2 away from the first edge 106. The first distance D1 may be larger than the second distance D2. In embodiments involving tracheid effect measurements, measurements from the first position 402 may be referred to as “TracNear.” Measurements from the second position 404 may be referred to as “TracFar.” A person of ordinary skill in the art will appreciate that similar optical measurements may be gathered from the bottom surface 104 as an alternative to or in addition to the measurements described with respect to the top surface 102. Further, as each wood product 100 may comprise many sections and/or coupons, numerous optical measurements may be obtained from a single wood product 100.

The optical measurements may then be used to calculate one or more slope values. Slope values according to the disclosure are values corresponding to an estimated rate at which the optical measurements vary across the wood product's length. In embodiments involving tracheid effect measurements, slope values may be referred to as “TracRatioSlope.” In methods according to the disclosure, a single slope value may be obtained or multiple slope values may be obtained for each individual measurement. Slope values may be used in a prediction model to determine a predictive output that indicates whether the wood product 100 originated from a butt log.

In some embodiments, additional measurements may be utilized to obtain the predictive output referenced above. For example, bulk density measurements, acoustic velocity measurements, and moisture content measurements are all examples of additional measurements that may be used according to embodiments of the disclosure.

A person of ordinary skill in the art will appreciate that numerous types of prediction models may be used with methods according to embodiments of the disclosure and that prediction models may be derived using various methods. For example, logistic regressions, linear regressions, support vector machines, and classification trees are all examples of suitable methods for prediction models and/or methods for deriving prediction models. Likewise, different types of predictive outputs may be generated according to embodiments of the disclosure. In some embodiments, the predictive output may be a probability or a number. In other embodiments, methods according to embodiments of the disclosure may simply indicate via a yes/no determination whether a wood product originated from a butt log. In other embodiments, a class label may be a suitable type of predictive output.

Those skilled in the art will appreciate that the system/method described herein may be implemented on any computing system or device. Suitable computing systems or devices include personal computers, server computers, multiprocessor systems, microprocessor-based systems, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed as desired in various embodiments.

From the foregoing, it will be appreciated that the specific embodiments of the disclosure have been described herein for purposes of illustration, but that various modifications may be made without deviating from the disclosure. For example, predictive outputs not explicitly listed that would be obvious to a person of ordinary skill in the art may be used with embodiments according to the disclosure.

Aspects of the disclosure described in the context of particular embodiments may be combined or eliminated in other embodiments. For example, aspects disclosed in reference to a particular example below may be combined or eliminated with aspects disclosed in reference to another example.

Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

The following examples will serve to illustrate aspects of the present disclosure. The examples are intended only as a means of illustration and should not be construed to limit the scope of the disclosure in any way. Those skilled in the art will recognize many variations that may be made without departing from the spirit of the disclosure.

### EXAMPLE 1

In a first example, methods according to embodiments of the disclosure were verified using lumber having a known origin as either a butt log or a top log. In a trial performed at Weyerhaeuser's Greenville saw mill in North Carolina, lumber was tracked using a bar code system and methods according to the disclosure were applied to determine whether the boards originated from butt logs. For the first example, a set of 1600 test pieces were selected.

Optical measurements were obtained by scanning each piece of lumber with a Tracheid scanner as implemented in a GradeScan® autograder manufactured and commercially available from Lucidyne Technologies Inc. of Corvallis, Oreg. Each reported Tracheid data value represents the difference in light level intensities (8-bit grayscale value) measured between two fixed lineal distances from the center of an incident laser line. Each piece of lumber was divided into coupons, each having a size equal to ¼ width×⅛ length of the lumber, and mean tracheid values were calculated for each coupon. Tracheid scan data as described above was acquired on both the top and bottom surface of each piece of lumber. TracNear measurements were acquired at a first position on the top surface and the bottom surface of each piece. TracFar measurements were acquired at a second position on the top surface The following variables were then obtained from the optical data:

TracNear Mean=mean of the 4 top and 4 bottom TracNear measurements for each coupon;

TracFar Mean=mean of the 4 top and 4 bottom TracFar measurements for each coupon; and

TracRatio=(TracNear Mean)/(TracFar/Mean).

TracRatioSlope=lengthwise mean gradient of TracRatio

The calculated TracRatioSlope variable was then used in a prediction model to calculate a predictive output. In this example, the prediction model was derived using a logistic regression model and is listed below as Model 1. The predictive output was a probability. If the probability was greater than 0.50, then the lumber was classified as originating from a butt log.

$$Predictive Output = \frac{1}{1 + {e}^{( A + B S )}} \qquad Equation 1$$

In Equation 1, A is a first coefficient and B is a second coefficient. S may be one of the one or more slope value (e.g., TracRatioSlope). S may also be a value selected using the one or more slope values. The particular values for A, B, and S may be calculated using any known statistical method. The miscalculation rate for Example 1 is shown below in Table 1.

TABLE 1
Miscalculation Rate for Example 1

Actual

| | | Upper Logs | Butt Logs |
|---|---|---|---|
| Predicted | Upper Logs | 1176 | 90 |
| | Butt Logs | 27 | 307 |

The method used in Example 1 predicted that 334 of the pieces originated from butt logs. Based on the bar code tracking, the actual number of pieces originating from butt logs was 307.

### EXAMPLE 2

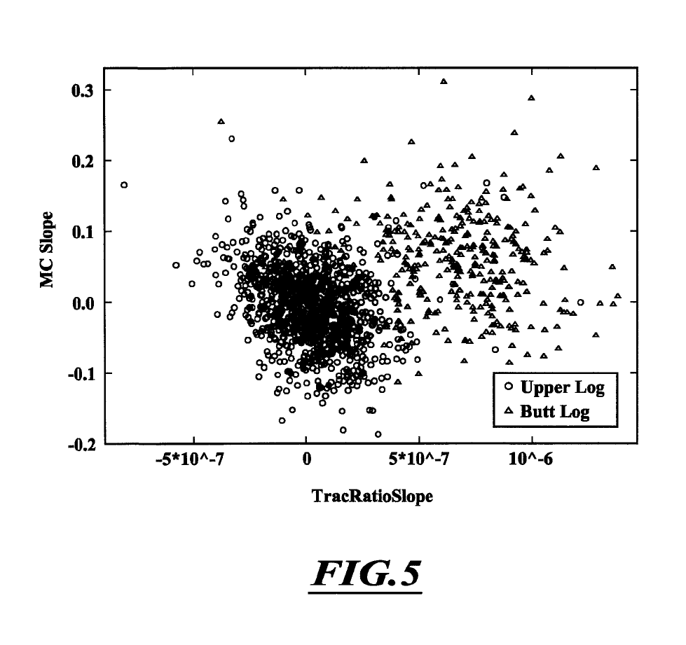

In a second example, methods according to embodiments of the disclosure were verified using lumber having a known origin as either a butt log or a top log. Optical measurements in accordance with those described in Example 1 were obtained. In addition to the optical measurements, additional measurements were taken for each piece of lumber. These additional measurements included acoustic velocity measurements, moisture content measurements, and density measurements. For the second example, a set of 1600 test pieces were selected. FIG. 5 is a plot of TracRatio slope vs. moisture content slope (estimated rate at which the moisture content changes along the length of the wood product). The different symbols on this plot show which pieces are from the butt log and which pieces are from the upper log. The plot shows that these two variables can be used to effectively discriminate between boards from butt and upper logs.

The calculated TracRatioSlope variable and additional measurements were then used in a prediction model to calculate a predictive output. In this example, the prediction model was derived using a logistic regression model and is listed below as Equation 2. The predictive output was a probability.

$$Predictive Output = \frac{1}{1 + {e}^{( C + 2 D ρ + E V + F S + G M + H I + J T + K ρ V )}} \qquad Equation 2$$

In Equation 2, C is a first coefficient, D is a second coefficient, E is a third coefficient, F is a fourth coefficient, G is a fifth coefficient, H is a sixth coefficient, I is a seventh coefficient, J is an eighth coefficient, and K is a ninth coefficient. S may be one of the one or more slope value (e.g., TracRatioSlope). S may also be a value selected using the one or more slope values. The acoustic velocity is represented by ρ. The coefficient V is derived from acoustic velocity measurements. The coefficient M is derived from moisture content measurements. The coefficient T can be derived from the optical measurements (e.g., TracFar). The particular values for the coefficients in the model above may be calculated using any known statistical method. The miscalculation rate for Example 2 is shown below in Table 2.

TABLE 2
Miscalculation Rate for Example 2

Actual

| | | Upper Logs | Butt Logs |
|---|---|---|---|
| Predicted | Upper Logs | 1172 | 64 |
| | Butt Logs | 25 | 330 |

The method used in Example 2 predicted that 355 of the pieces originated from butt logs. Based on the bar code tracking, the actual number of pieces originating from butt logs was 330.

### EXAMPLE 3

In a third example, methods according to embodiments of the disclosure were verified using lumber having a known origin as either a butt log or a top log. Optical measurements in accordance with those described in Example 1 were obtained. In addition to the optical measurements, additional measurements were taken for each piece of lumber. These additional measurements included acoustic velocity measurements, moisture content measurements, and density measurements. For the third example, a set of 1390 test pieces were selected.

The calculated TracRatio variable and additional measurements were then used in a prediction model to calculate a predictive output. In this example, the prediction model was derived using a linear regression model and is listed below as Equation 3. The predictive output was a probability.

Predictive Output=L+N*S+P*M Equation 3:

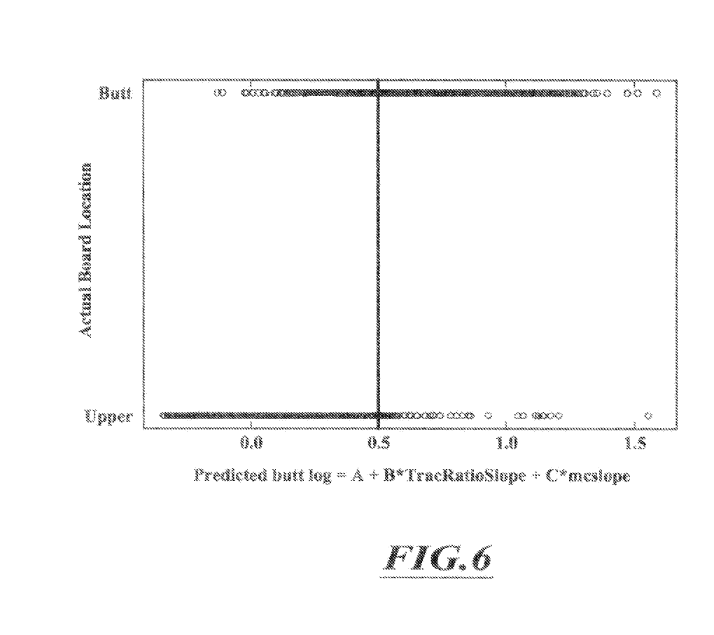

In Equation 3, L is a first coefficient, N is a second coefficient, and P is a third coefficient. S may be one of the one or more slope value (e.g., TracRatio). S may also be a value selected using the one or more slope values. The coefficient M is derived from moisture content measurements. The particular values for the coefficients in the model above may be calculated using any known statistical method. The miscalculation rate for Example 3 is shown below in Table 3. FIG. 6 is a plot showing predicted origin location vs. actual origin location.

TABLE 3
Miscalculation Rate for Example 3

Actual

| | | Upper Logs | Butt Logs |
|---|---|---|---|
| Predicted | Upper Logs | 967 | 67 |
| | Butt Logs | 26 | 330 |

The method used in Example 3 predicted that 356 of the pieces originated from butt logs. Based on the bar code tracking, the actual number of pieces originating from butt logs was 330.

### EXAMPLE 4

In a fourth example, methods according to embodiments of the disclosure were verified using lumber having a known origin as either a butt log or a top log. Optical measurements in accordance with those described in Example 1 were obtained. In addition to the optical measurements, additional measurements were taken for each piece of lumber. These additional measurements included acoustic velocity measurements, moisture content measurements, and density measurements. For the third example, a set of 1317 test pieces were selected.

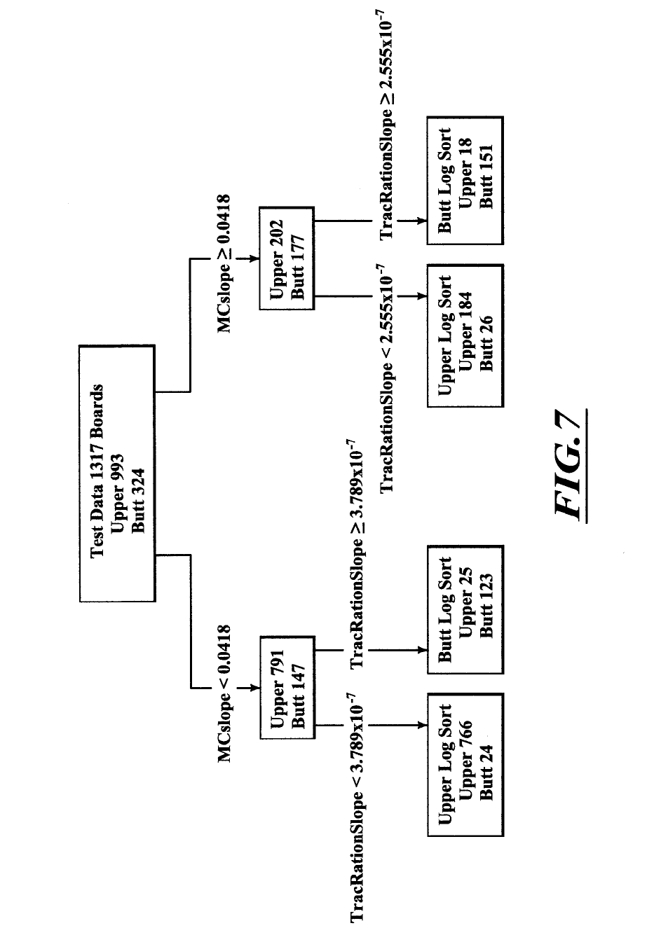

The calculated TracRatio variable and additional measurements were then used in a prediction model to calculate a predictive output. In this example, the prediction model was derived using a classification tree. FIG. 7 is a schematic showing an example of this technique.

The method used in Example 4 predicted that 317 of the pieces originated from butt logs. Based on the bar code tracking, the actual number of pieces originating from butt logs was 274.

I/We claim:

1. A method for predicting whether a wood product originated from a butt log comprising the steps of:
dividing the wood product into at least two sections;
obtaining, for each of the at least two sections, one or more optical measurements;
calculating one or more slope values, the one or more slope values each representing an estimated rate at which the one or more optical measurements vary across the wood product; and
using the one or more slope values in a prediction model to determine a predictive output, the predictive output indicating whether the wood product originated from a butt log.

2. The method of claim 1 wherein the step of dividing the wood product into at least two sections comprises dividing the wood product along the wood product's length.

3. The method of claim 1 wherein the step of obtaining, for each of the at least two sections, one or more optical measurements comprises:
obtaining one or more optical measurements from a first position on each of the at least two sections; and
obtaining one or more optical measurements from a second position on each of the at least two sections.

4. The method of claim 1 wherein the wood product has a top surface and a bottom surface and the step of obtaining, for each of the at least two sections, one or more optical measurements comprises:
obtaining one or more optical measurements from the top surface; and
obtaining one or more optical measurements from the bottom surface.

5. The method of claim 3 wherein the one or more optical measurements comprise reflected intensities of light from a laser line directed on the wood product.

6. The method of claim 1, further comprising the steps of:
obtaining one or more additional measurements of the wood product, the one or more additional measurements being selected from the group consisting of: bulk density measurements, acoustic velocity measurements, and moisture content measurements; and
using the one or more additional measurements, in addition to the one or more slope values, in the prediction model to determine the predictive output.

7. The method of claim 1 wherein the prediction model is derived using logistic regressions, linear regressions, support vector machines, and or classification trees.

8. The method of claim 1 wherein the predictive output is selected from the group consisting of: numbers, class labels, probabilities, and yes/no determinations.

9. The method of claim 1 wherein the prediction model is:
$$Predictive Output = \frac{1}{1 + {e}^{( A + B S )}}$$
wherein A is a first coefficient;
wherein B is a second coefficient; and
wherein S is one of the one or more slope values or a value selected using the one or more slope values.

10. The method of claim 1 wherein the prediction model is a classification or regression tree.

11. A method for predicting whether a wood product originated from a butt log comprising the steps of:
providing a wood product having a top surface, a bottom surface, a first edge, a second edge, a length, and a width;
dividing the wood product along the length into at least two sections;
dividing each of the at least two sections along the width into at least two coupons;
obtaining, for each of the at least two coupons, one or more optical measurements from the top surface of the wood product at a first position;
obtaining, for each of the at least two coupons, one or more optical measurements from the top surface of the wood product at a second position, the second position being further from the wood product's first edge than the first position;
obtaining, for each of the at least two coupons, one or more optical measurements from the bottom surface of the wood product at the first position;
obtaining, for each of the at least coupons, one or more optical measurements from the bottom surface of the wood product at the second position;
calculating one or more slope values, the one or more slope values each representing an estimated rate at which the one or more optical measurements vary across the wood product's length; and
using the one or more slope values in a prediction model to determine a predictive output, the predictive output indicating whether the wood product originated from a butt log.

12. The method of claim 11 wherein the one or more optical measurements comprise reflected intensities of light from a laser line directed on the wood product.

13. The method of claim 11, further comprising the steps of:
obtaining one or more additional measurements of the wood product, the one or more additional measurements being selected from the group consisting of: bulk density measurements, acoustic velocity measurements, and moisture content measurements; and
using the one or more additional measurements, in addition to the one or more slope values, in the prediction model to determine the predictive output.

14. The method of claim 11 wherein the prediction model is derived using logistic regressions, linear regressions, support vector machines, or classification trees.

15. The method of claim 11 wherein the predictive output is selected from the group consisting of: numbers, class labels, probabilities, and yes/no determinations.

16. A computer-readable storage medium storing computer-executable instructions that, when executed, cause a computing system to perform a method for determining whether a wood product originated from a butt log, the method comprising the steps of:
dividing the wood product into at least two sections;
obtaining, for each of the at least two sections, one or more optical measurements;
calculating one or more slope values, the one or more slope values each representing an estimated rate at which the one or more optical measurements vary across the wood product; and
using the one or more slope values in a prediction model to determine a predictive output, the predictive output indicating whether the wood product originated from a butt log.

17. The computer-readable storage medium of claim 16 wherein the prediction model is derived using logistic regressions, linear regressions, support vector machines, or classification trees.

18. The computer-readable storage medium of claim 16 wherein the predictive output is selected from the group consisting of: numbers, class labels, probabilities, and yes/no determinations.

19. The computer-readable storage medium of claim 16 wherein the one or more optical measurements comprise reflected intensities of light from a laser line directed on the wood product.

20. The computer-readable storage medium of claim 16, further comprising the steps of:
obtaining one or more additional measurements of the wood product, the one or more additional measurements being selected from the group consisting of: bulk density measurements, acoustic velocity measurements, and moisture content measurements; and
using the one or more additional measurements, in addition to the one or more slope values, in the prediction model to determine the predictive output.
